(19) United States
(12) Patent Application Publication
(10) Pub. No.: US 2019/0168139 A1
(43) Pub. Date: Jun. 6, 2019

(54) MULTI-SHAFT LAMINATED SPIRAL SOLID-LIQUID SEPARATOR WITH PENDULUM MOTION

(71) Applicant: YUNPING WU, FUZHOU CITY, FUJIAN PROVINCE (CN)

(72) Inventor: YUNPING WU, FUZHOU CITY, FUJIAN PROVINCE (CN)

(21) Appl. No.: 16/321,830

(22) PCT Filed: Apr. 21, 2017
(86) PCT No.: PCT/CN2017/081348

§ 371 Date: Jan. 30, 2019

(51) Int. Cl. B01D 33/29; B01D 33/39; B01D 33/80

(52) U.S. Cl. CPC B01D 33/29; B01D 33/801; B01D 33/39

(57) ABSTRACT

Disclosed is a multi-shaft laminated spiral solid-liquid separator with a pendulum motion, the separator comprising fixed rings, movable rings and screw shafts, wherein each of the screw shafts is provided with the fixed rings and the movable rings in a staggered arrangement in a radial direction to form a cavity; there are two or more screw shafts arranged in the cavity side by side, and the fixed rings and the movable rings are in the form of an annular structure with two rings staggered and communicated or multiple rings staggered and communicated.

### BACKGROUND OF THE INVENTION

### 1. Technical Field

The present invention relates to the technical field of solid-liquid separation equipment, and in particular, to a multi-shaft laminated spiral solid-liquid separator with a pendulum motion.

### 2. Background

Chinese invention patent No. 200780018706.9 discloses a laminated spiral solid-liquid separator, which includes: a solid-liquid separation part provided with multiple adjacent fixed rings and multiple movable rings disposed between the adjacent fixed rings; and at least one screw extending through the solid-liquid separation part. The movable rings are designed to be driven by the rotating screw, in such a manner that the filtrate from a processed object entering the solid-liquid separation part is drained out of the solid-liquid separation part while the processed object is moved towards an outlet of the solid-liquid separation part. For this laminated spiral solid-liquid separator, the contact between the movable rings and a screw shaft leads to abrasion therebetween.

Chinese invention patent No. 200810043376.5 discloses a novel spiral solid-liquid separator, where movable rings are eccentrically driven by an eccentric shaft to avoid abrasion between the movable rings and the screw shaft. However, for a drive manner using such a structure, deformation easily occurs since no extra support part is provided on the eccentric shaft. Even worse, a large machine cannot be driven due to high load bearing. In addition, a drive rod for driving the movable rings easily deforms and bends.

Chinese invention patent No. 200510054707.1 discloses an anti-wear laminated spiral solid-liquid separator, where fixed rings and movable rings are arranged in tiers to jointly form a cavity structure, and a screw shaft passes through the cavity structure. The movable rings are driven up and down by an external driver, but can only move around the periphery of the screw shaft. During processing of high-fiber-content sludge which easily hardens, the materials easily accumulate on the screw shaft and cannot be propelled smoothly, reducing the processing capacity and easily causing overload or a machine failure. Moreover, no effective moisture is separated from the sludge near the shaft center and drained out of a channel, failing to reduce its moisture content.

Chinese invention patent No. 200510054707.1 discloses a solid-liquid separator with two screw shafts. However, in this machine, a cover is provided around the upper portions of the screw shafts, and a movable plate or fixed plate is provided on their lower portions. The movable plate contacts the screw shafts, which inevitably causes abrasion.

### SUMMARY OF THE INVENTION

A technical problem to be solved by the present invention is to provide a multi-shaft laminated spiral solid-liquid separator with a pendulum motion, where a drive rod is less likely to deform and is applicable to a large-scale apparatus.

The present invention is implemented as follows:

A multi-shaft laminated spiral solid-liquid separator with a pendulum motion includes: fixed rings, movable rings and screw shafts, where each of the screw shafts is provided with the fixed rings and the movable rings in a staggered arrangement in a radial direction to form a cavity.

There are two or more screw shafts arranged in the cavity side by side, and the fixed rings and the movable rings are in the form of an annular structure with two rings staggered and communicated or multiple rings staggered and communicated.

The separator further includes a primary drive rod, a secondary drive rod, and a guide rod.

The primary drive rod is connected to an independent drive motor, or is connected to the screw shafts via a transmission mechanism.

The primary drive rod is supported by two or more support devices, and one or more eccentric devices are provided on the primary drive rod.

Each of the eccentric devices is connected to the secondary drive rod via a drive sheet; the secondary drive rod is sleeved in the lower ends of the movable rings and connects all of the movable rings together to form one piece; the guide rod passes through the upper ends of the movable rings and connects all of the movable rings together to form one piece; and the secondary drive rod drives the lower ends of the movable rings to make a pendulum motion while the guide rod drives the movable rings to move up and down by means of one linear guide device.

The transmission mechanism or the drive motor drives the primary drive rod to move, the eccentric devices on the primary drive rod drive the secondary drive rod to move, and the secondary drive rod drives all the movable rings to move.

Further, the primary drive rod is disposed above the guide rod; while being driven by the eccentric devices to move, the primary drive rod drives the guide rod to move up and down and levers, about the guide rod, the secondary drive rod to swing.

Further, the transmission mechanism is a gear transmission mechanism; there are two screw shafts; the screw shafts are driven by the gear transmission mechanism to operate in the same direction; the gear transmission mechanism includes a driving screw shaft gear, a driven screw shaft gear, a transmission gear, and a primary drive rod gear; and the transmission gear engages with the driving screw shaft gear, the driven screw shaft gear, and the primary drive rod gear.

Further, the transmission mechanism is a gear transmission mechanism; there are two screw shafts; the screw shafts are driven by a gear transmission mechanism to operate in reverse directions; the gear transmission mechanism includes a driving screw shaft gear, a driven screw shaft gear, a transmission gear, and a primary drive rod gear; the driving screw shaft gear engages with the transmission gear and the driven screw shaft gear; and the transmission gear further engages with the primary drive rod gear.

The present invention has the following advantages: 1. The present invention uses two or more screw shafts to replace one screw shaft, and blades of the adjacent screw shafts partially overlap. Therefore, during rotation of the screw shafts, materials which easily harden into a block near the shaft centers are rolled, to successively push materials forward. Thus, all the materials are thoroughly and uniformly rolled to the periphery of the cavity, facilitating drainage of moisture. Moreover, the screw shafts are arranged side by side, and the fixed rings and the movable rings cling to the screw shafts on the circumference. Therefore, the whole cavity is flat, and the drainage area at the bottom is widened, thus better facilitating the drainage of moisture. Especially, when the screw shafts operate in reverse directions, the moisture content in the materials which can withstand the stress can be further reduced since the screw blades get close to each other during operation. 2. The primary drive rod of the present invention is arranged outside the solid-liquid separation cavity, and is supported by two or more support devices. Further, the primary drive rod is provided with multiple eccentric devices which drive the movable rings to move. Therefore, abrasion caused by the contact between the movable rings and the screw shafts is avoided, and further a multi-shaft design is made feasible. In addition, such a drive manner fundamentally eliminates occurrence of deformation of the drive rod in the prior art. 3. Gear transmission is applied between shafts to adapt to the increased volume of the cavity, which enhances the processing capacity of each individual shaft by using an energy-efficient method. 4. The primary drive rod is disposed above a water extractor, thus avoiding the eccentric devices and the support devices on the primary drive rod from being frequently immersed in waste water, and facilitating observation of driver operation and maintenance and replacement.

### BRIEF DESCRIPTION OF THE DRAWINGS

The present invention is further described below with reference to the accompanying drawings.

FIG. 1 is a schematic structural illustration of the present invention;

FIG. 2 is a schematic structural illustration of a support plate of the present invention;

FIG. 3 is a schematic structural illustration of a fixed ring of the present invention;

FIG. 4 is a schematic structural illustration of a movable ring of the present invention;

FIG. 5 is a schematic structural illustration of a transmission movable ring of the present invention;

FIG. 6 is a top view when two screw shafts of the present invention operate in the same direction (a primary drive rod is not shown);

FIG. 7 is a schematic structural illustration of a gear transmission mechanism when the two screw shafts of the present invention operate in the same direction;

FIG. 8 is a top view when the two screw shafts of the present invention operate in reverse directions (a primary drive rod is not shown); and

FIG. 9 is a schematic structural diagram of a gear transmission mechanism when the two screw shafts of the present invention operate in reverse directions.

### DETAILED DESCRIPTION OF THE PREFERRED EMBODIMENTS

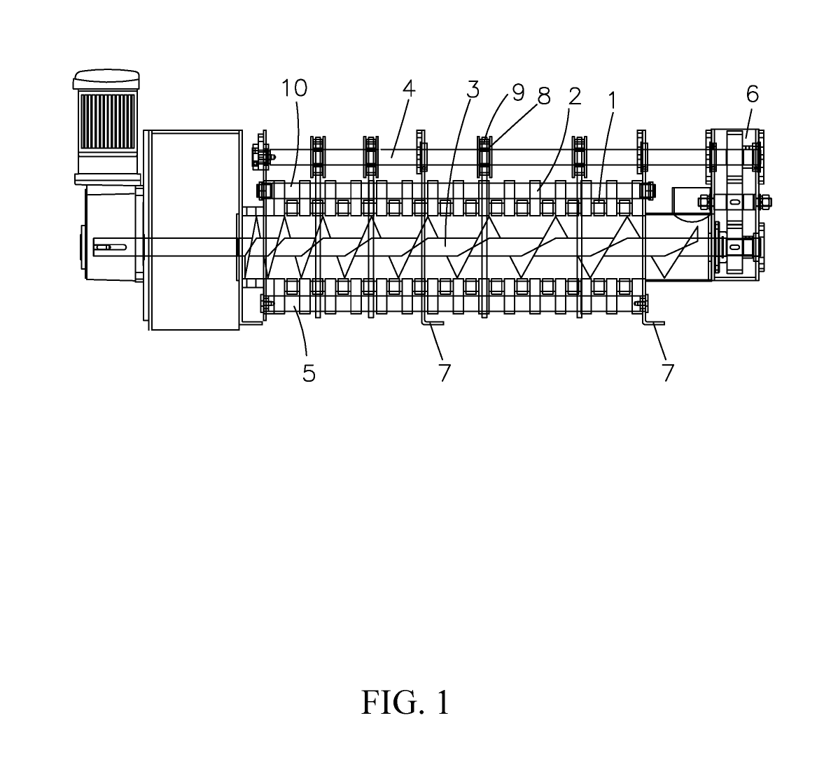

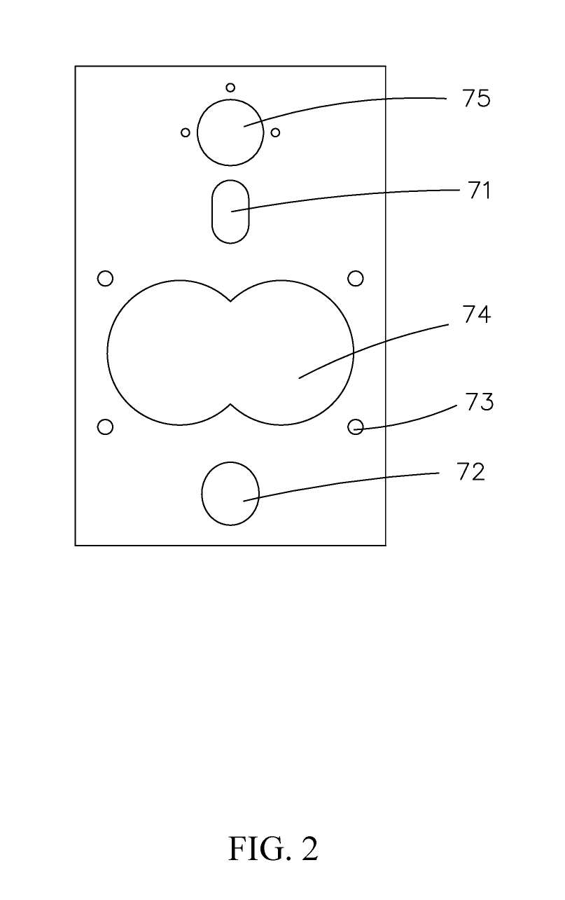

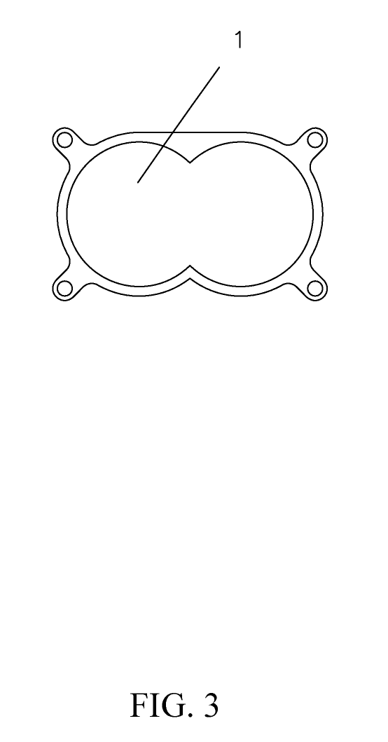

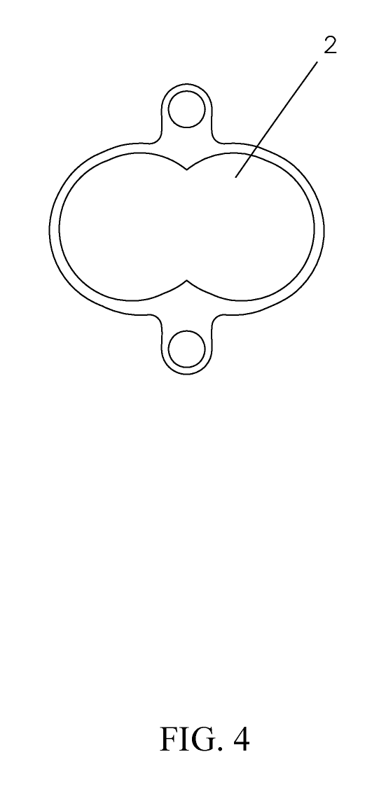

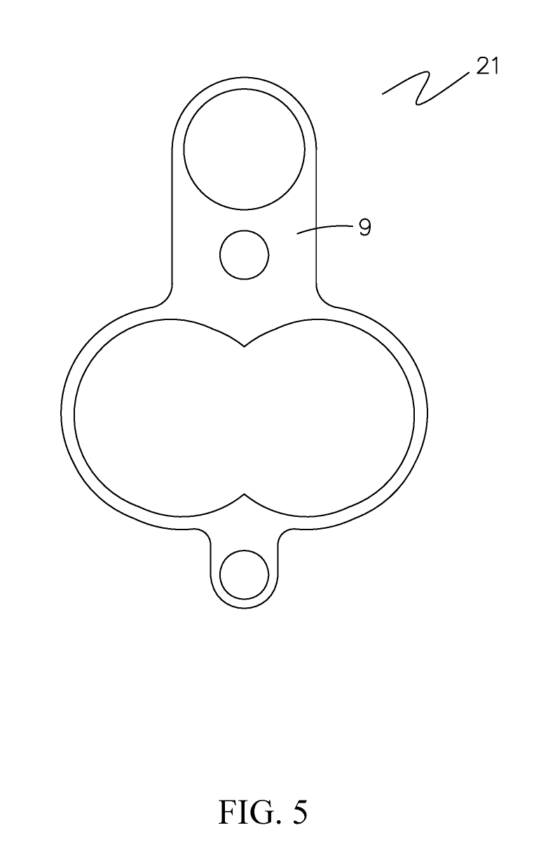

As shown in FIG. 1 to FIG. 5, a multi-shaft laminated spiral solid-liquid separator with a pendulum motion includes fixed rings 1, movable rings 2, and two screw shafts 3 arranged side by side, where each of the screw shafts 3 is provided with the fixed rings 1 and the movable rings 2 in a staggered arrangement in a radial direction to form a cavity.

The separator further includes a primary drive rod 4, a secondary drive rod 5, and a guide rod 10.

The screw shafts 3 are connected to the primary drive rod 4 via a transmission mechanism 6, where the transmission mechanism 6 may use gear transmission, sprocket transmission, or belt transmission. However, the primary drive rod 4 is not necessarily driven by the screw shafts 3, and may also be connected to and driven by an independent drive motor (not shown in the figure).

The primary drive rod 4 is disposed above the cavity and supported by two support plates 7. Four eccentric bearings 8 are provided on the primary drive rod 4 at intervals.

Each of the eccentric bearings 8 is connected to the secondary drive rod 5 via a drive sheet 9. The secondary drive rod 5 is sleeved in the lower ends of the movable rings 2 and connects all of the movable rings 2 together to form one piece. The drive sheets 9 and their corresponding movable rings 2 are integrally connected. The movable ring 2 provided with the drive sheet 9 is referred to as a transmission movable ring 21.

The support plate 7 is provided with a guide device 71, a giving-way hole 72, pillar holes 73 connected to the fixed ring 1, a cavity hole 74 for accommodating a solid-liquid separation part, and a fixing hole 75 for fixing the primary drive rod 4.

The guide rod 10 is sleeved in the upper ends of the movable rings 2 and connects all of the movable rings 2 together to form one piece. The guide rod 10 passes through the guide device 71 on the support plate 7. The guide device 71 is a linear hole, and is used to give way to the guide rod 10 to make a linear motion. The secondary drive rod 5 passes through the giving-way hole 72 on the support plate 7, and the giving-way hole 72 is used to give way to the secondary drive rod 5 to make a pendulum motion. The fixing hole 75 is used for fixing the primary drive rod 4.

The screw shafts 3 drive the primary drive rod 4 to move via the transmission mechanism 6, the eccentric bearings 8 on the primary drive rod 4 drive the transmission movable rings 21 to move, and the transmission movable rings 21 drive all the movable rings 2 to move via the secondary drive rod 5. Under the effect of the eccentric bearings 8 and the guide devices 71, the guide rod 10 drives the upper ends of all the movable rings 2 to make a linear motion. Under the effect of the eccentric bearings 8 and the giving-way holes 72, the secondary drive rod 5 drives the lower ends of all the movable rings 21 to make a pendulum motion.

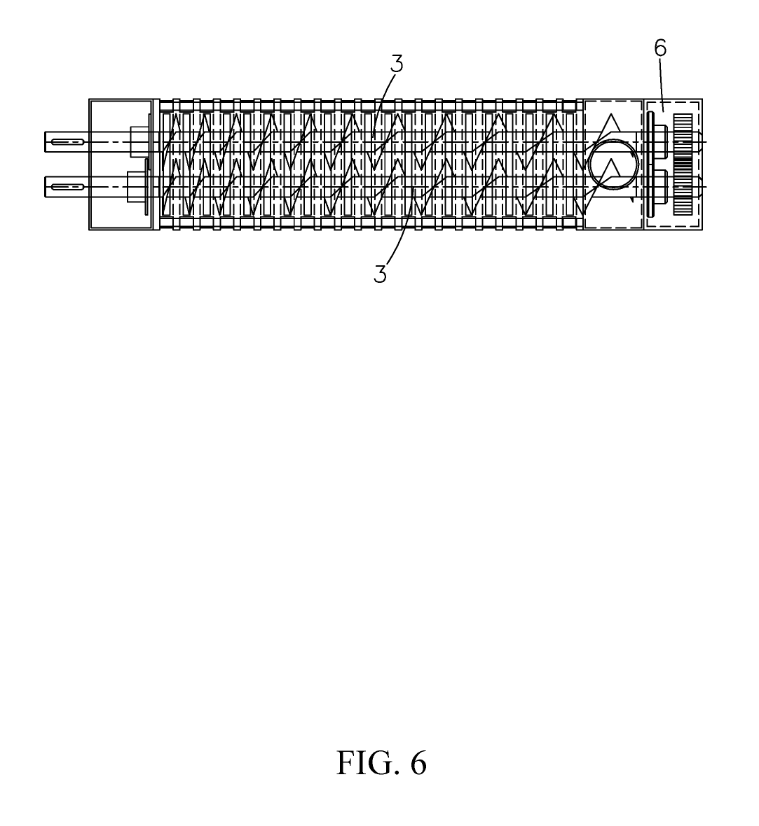

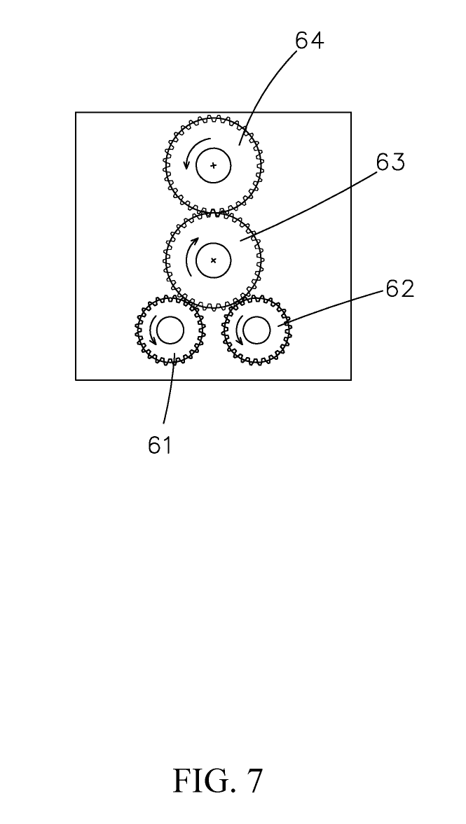

As shown in FIG. 6 and FIG. 7, the two screw shafts 3 are driven by a gear transmission mechanism 6 to operate in the same direction. The gear transmission mechanism 6 includes a driving screw shaft gear 61, a driven screw shaft gear 62, a transmission gear 63, and a primary drive rod gear 64. The transmission gear 63 engages with the driving screw shaft gear 61, the driven screw shaft gear 62, and the primary drive rod gear 64.

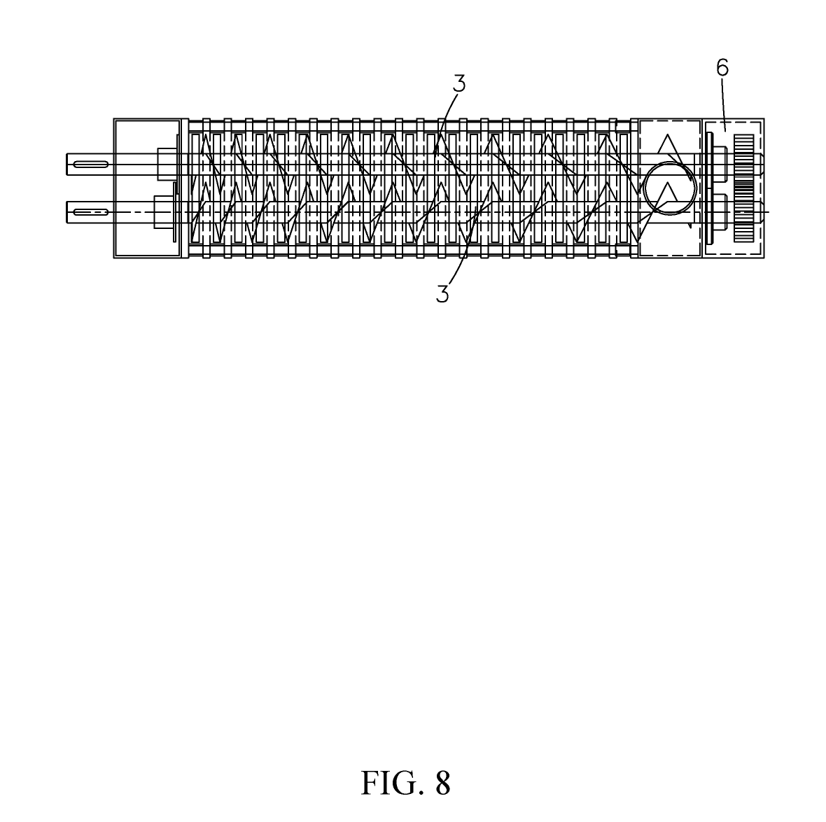

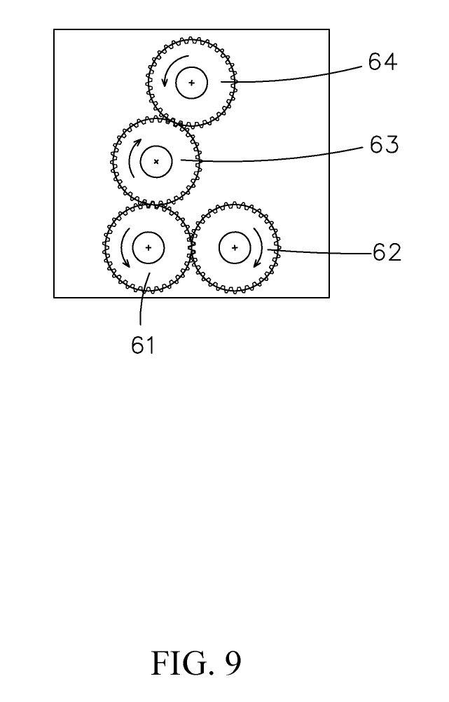

As shown in FIG. 8 and FIG. 9, the two screw shafts 3 are driven by a gear transmission mechanism 6 to operate in reverse directions. The gear transmission mechanism 6 includes a driving screw shaft gear 61, a driven screw shaft gear 62, a transmission gear 63, and a primary drive rod gear 64. The driving screw shaft gear 61 engages with the transmission gear 63 and the driven screw shaft gear 62; and the transmission gear 63 further engages with the primary drive rod gear 64.

The above merely describes preferred embodiments of the present application, but is not intended to limit the protection scope of the present invention. Any modifications, equivalent replacements or improvements made within the spirit and principle of the present application shall fall within the protection scope of the present invention.

1. A multi-shaft laminated spiral solid-liquid separator with a pendulum motion, comprising: fixed rings, movable rings and screw shafts, wherein each of the screw shafts is provided with the fixed rings and the movable rings in a staggered arrangement in a radial direction to form a cavity;
the two or more screw shafts arranged in the cavity side by side, and the fixed rings and the movable rings are in the form of an annular structure with two rings staggered and communicated or multiple rings staggered and communicated;
the separator further comprises a primary drive rod, a secondary drive rod, and a guide rod, wherein
the primary drive rod is connected to an independent drive motor, or is connected to the screw shafts via a transmission mechanism;
the primary drive rod is supported by two or more support devices, and one or more eccentric devices are provided on the primary drive rod;
each of the eccentric devices is connected to the secondary drive rod via a drive sheet;
the secondary drive rod is sleeved in the lower ends of the movable rings and connects all of the movable rings together to form one piece; the guide rod passes through the upper ends of the movable rings and connects all of the movable rings together to form one piece; and the secondary drive rod drives the lower ends of the movable rings to make a pendulum motion while the guide rod drives the movable rings to move up and down by means of a linear guide device; and
the transmission mechanism or the drive motor drives the primary drive rod to move, the eccentric devices on the primary drive rod drive the secondary drive rod to move, and the secondary drive rod drives all the movable rings to move.

2. The multi-shaft laminated spiral solid-liquid separator with a pendulum motion of claim 1, wherein the primary drive rod is disposed above the guide rod; while being driven by the eccentric devices to move, the primary drive rod drives the guide rod to move up and down and levers, about the guide rod, the secondary drive rod to swing.

3. The multi-shaft laminated spiral solid-liquid separator with a pendulum motion of claim 1, wherein the transmission mechanism is a gear transmission mechanism; there are two screw shafts; the screw shafts are driven by the gear transmission mechanism to operate in the same direction; the gear transmission mechanism comprises a driving screw shaft gear, a driven screw shaft gear, a transmission gear, and a primary drive rod gear; and the transmission gear engages with the driving screw shaft gear, the driven screw shaft gear, and the primary drive rod gear.

4. The multi-shaft laminated spiral solid-liquid separator with a pendulum motion of claim 1, wherein the transmission mechanism is a gear transmission mechanism; there are two screw shafts; the screw shafts are driven by a gear transmission mechanism to operate in reverse directions; the gear transmission mechanism comprises a driving screw shaft gear, a driven screw shaft gear, a transmission gear, and a primary drive rod gear; the driving screw shaft gear engages with the transmission gear and the driven screw shaft gear; and the transmission gear further engages with the primary drive rod gear.

5. The multi-shaft laminated spiral solid-liquid separator with a pendulum motion of claim 2, wherein the transmission mechanism is a gear transmission mechanism; there are two screw shafts; the screw shafts are driven by the gear transmission mechanism to operate in the same direction; the gear transmission mechanism comprises a driving screw shaft gear, a driven screw shaft gear, a transmission gear, and a primary drive rod gear; and the transmission gear engages with the driving screw shaft gear, the driven screw shaft gear, and the primary drive rod gear.

6. The multi-shaft laminated spiral solid-liquid separator with a pendulum motion of claim 2, wherein the transmission mechanism is a gear transmission mechanism; there are two screw shafts; the screw shafts are driven by a gear transmission mechanism to operate in reverse directions; the gear transmission mechanism comprises a driving screw shaft gear, a driven screw shaft gear, a transmission gear, and a primary drive rod gear; the driving screw shaft gear engages with the transmission gear and the driven screw shaft gear; and the transmission gear further engages with the primary drive rod gear.
